(19) United States
(12) Patent Application Publication
(10) Pub. No.: US 2026/0220852 A1
(43) Pub. Date: Jul. 30, 2026

(54) DISPLAY SYSTEM, INFORMATION PROCESSING DEVICE, AND CONTROL METHOD FOR INFORMATION PROCESSING DEVICE

(71) Applicant: SEIKO CORPORATION, Tokyo (JP)

(72) Inventor: Toshiyuki SAKAI, Matsumoto-shi (JP)

(73) Assignee: SEIKO CORPORATION, Tokyo (JP)

(21) Appl. No.: 19/460,944

(22) Filed: Jan. 27, 2026

(30) Foreign Application Priority Data
Jan. 28, 2025 (JP) 2025-012102

(51) Int. Cl. G06T 11/60; G06F 40/14

(52) U.S. Cl. CPC G06T 11/60; G06F 40/14; G06T 2200/24; G06T 2210/62

(57) ABSTRACT

According to an aspect of the present disclosure, there is provided a display system including an information processing device and a projection device. The information processing device includes a first controller configured to execute a first HTML file with a web browser to perform acquiring a second HTML file, superimposing, on a content frame excluding a content display on which content included in the acquired second HTML file is displayed, a mask image having the same color as a background color of the content display to generate composite image data, causing a browser window displayed on a display by the web browser to display a composite image based on the composite image data, and transmitting the composite image data to the projection device.

The present application is based on, and claims priority from JP Application Serial Number 2025-012102, filed Jan. 28, 2025, the disclosure of which is hereby incorporated by reference herein in its entirety.

### BACKGROUND

### 1. Technical Field

The present disclosure relates to a display system, an information processing device, and a control method for an information processing device.

### 2. Related Art

There has been known an information processing device that is connected to a display device and supplies image data to be displayed on the display device.

For example, JP-A-2002-247539 discloses a network projector device that operates the projector device using a web browser operating on information equipment for operation connected to the projector device via a network.

JP-A-2002-247539 is an example of the related art.

However, an aspect ratio of an image that a user desires to display and an aspect ratio of a browser screen of a web browser do not always coincide. In some cases, only by enlarging or reducing the browser screen, the user cannot display an image as the user desires to display the image on a display surface with a projection device.

### SUMMARY

According to an aspect of the present disclosure, there is provided a display system including: a display device configured to display an image on a display surface; and an information processing device, wherein the information processing device includes: a first communicator; a display; and a first controller configured to execute a first HTML file with a web browser to execute: acquiring a second HTML file; superimposing, on a second region excluding a first region where content included in the acquired second HTML file is displayed, a mask image having a same color as the background color of the first region to generate composite image data; causing a browser window displayed on the display by the web browser to display a composite image based on the composite image data; and transmitting the composite image data to the display device, and the display device includes: a second communicator; and a display configured to display, on the display surface, a composite image based on the composite image data received by the second communicator.

According to an aspect of the present disclosure, there is provided an information processing device including: a first communicator; a display; and a first controller configured to perform: acquiring, by executing a first HTML file with a web browser, a second HTML file; superimposing, on a second region excluding a first region where content included in the acquired second HTML file is displayed, a mask image having a same color as the background color of the first region to generate composite image data; causing a browser window displayed on the display by the web browser to display a composite image based on the composite image data; and transmitting the composite image data to the display device.

According to an aspect of the present disclosure, there is provided a control method for an information processing device including a first communicator configured to communicate with a display device; and a display, the control method causing a computer mounted on the information processing device to execute a first HTML file with a web browser to perform: acquiring a second HTML file; superimposing, on a second region excluding a first region where content included in the acquired second HTML file is displayed, a mask image having a same color as the background color of the first region to generate composite image data; causing a browser window displayed on the display by the web browser to display a composite image based on the composite image data; and transmitting the composite image data to the display device.

### BRIEF DESCRIPTION OF THE DRAWINGS

FIG. 1 is a diagram illustrating a system configuration of a display system.

FIG. 2 is a block diagram illustrating configurations of an information processing device and a projection device.

FIG. 3 is a flowchart illustrating an operation of the information processing device.

FIG. 4 is a diagram illustrating an example of a browser screen in a first embodiment.

FIG. 5 is a diagram illustrating an example of the browser screen in the first embodiment.

FIG. 6 is a diagram illustrating an example of the browser screen in the first embodiment.

FIG. 7 is a diagram illustrating an example of the browser screen in the first embodiment.

FIG. 8 is a diagram illustrating an image showing a predetermined motion of a mouse cursor.

FIG. 9 is a diagram illustrating an example of a browser screen in a second embodiment.

FIG. 10 is a diagram illustrating an example of the browser screen in the second embodiment.

FIG. 11 is a diagram illustrating an example of the browser screen in the second embodiment.

### DESCRIPTION OF EMBODIMENTS

### 1. System Configuration of a Display System in a First Embodiment

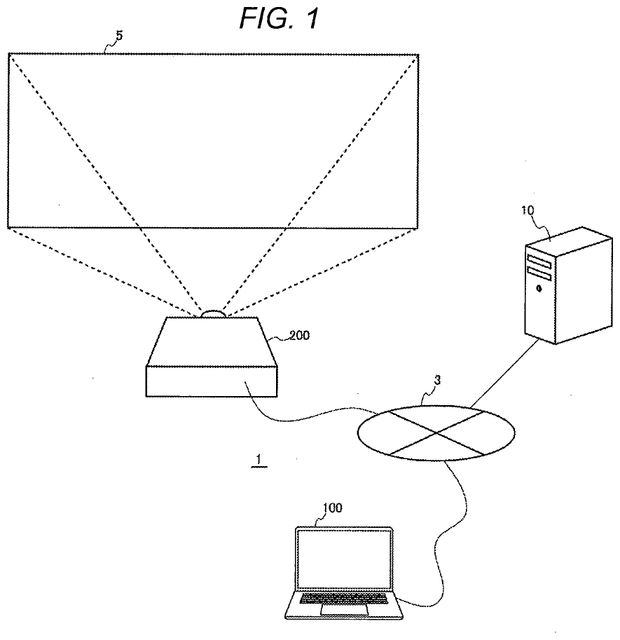

FIG. 1 is a diagram illustrating a system configuration of a display system 1 in a first embodiment.

The display system 1 in the first embodiment includes an information processing device 100 and a projection device 200. These devices are connected via a network 3. A server device 10 is also connected to the network 3.

Examples of the network 3 include a local area network (LAN), a wide area network (WAN), and the Internet. The network 3 is a communication line through which the information processing device 100 and the projection device 200 and the information processing device 100 and the server device 10 are respectively capable of performing data communication with each other.

The information processing device 100 is a device that supplies image data to be projected by the projection device 200. The information processing device 100 is, for example, a notebook computer, desktop computer, or tablet personal computer.

The projection device 200 generates image light based on the image data supplied from the information processing device 100 and projects the generated image light onto a projection surface 5. Accordingly, an image based on the image data is displayed on the projection surface 5. The projection device 200 is equivalent to a display device and the projection surface 5 is equivalent to a display surface.

The server device 10 is a server that provides a second hypertext markup language (HTML) file. The information processing device 100 executes browser software, accesses the server device 10, and acquires the second HTML file selected by operation of a user.

### 2. Configuration of the Information Processing Device

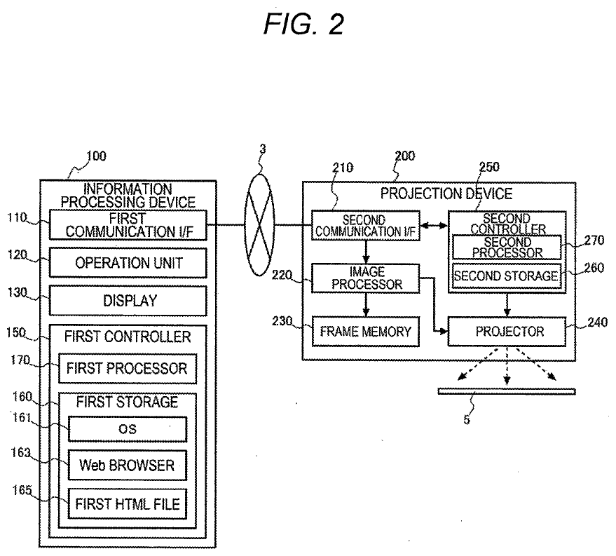

FIG. 2 is a block diagram illustrating configurations of the information processing device 100 and the projection device 200.

The configurations of the information processing device 100 and the projection device 200 are described with reference to FIG. 2. First, the configuration of the information processing device 100 is described.

The information processing device 100 includes a first communication interface 110, an operation unit 120, a display 130, and a first controller 150. Hereinafter, interface is abbreviated as I/F.

The first communication I/F 110 is equivalent to a first communicator. The first communication I/F 110 includes, for example, a communication card such as a network interface card (NIC) and performs data communication with the projection device 200 and the server device 10 via the network 3. In FIG. 2, an example in which the first communication I/F 110 is connected to the network 3 via a wired connection is illustrated. However, the connection between the information processing device 100 and the network 3 may be wireless connection by Wi-Fi or the like. Wi-Fi is a registered trademark.

The operation unit 120 includes an input device such as a mouse or a keyboard and functions as a receiver that receives operation of the user.

The display 130 includes a display panel such as a liquid crystal panel or an organic electro-luminescence (EL) panel and displays an image on the display panel according to control of the first controller 150.

The first controller 150 is a computer device including a first storage 160 and a first processor 170.

The first storage 160 includes a read only memory (ROM) and a random access memory (RAM). The ROM stores an operating system (OS) 161, a web browser 163, and a first HTML file 165, which is an HTML file. The web browser 163 is an application program having a function of accessing the server device 10 and displaying a web page provided by the server device 10. An HTML file stored by the first storage 160 is referred to as first HTML file 165 and an HTML file acquired from the server device 10 is referred to as second HTML file. The first HTML file 165 includes a program for superimposing a mask image on an image based on the second HTML file when the second HTML file is displayed. The RAM is used to temporarily store various data such as arithmetic operation data of the first processor 170.

The first processor 170 is an arithmetic processing device including a central processing unit (CPU) or a micro-processing unit (MPU). The first processor 170 may include a single processor or may include a plurality of processors. The first processor 170 may include an SoC integrated with a part or the entire first storage 160 and other circuits. The first processor 170 may include a combination of a CPU that executes a program and a digital signal processor (DSP) that executes predetermined arithmetic processing.

### 3. Configuration of the Projection Device

Next, the configuration of the projection device 200 is described.

The projection device 200 includes a second communication I/F 210, an image processor 220, a frame memory 230, a projector 240, and a second controller 250.

The second communication I/F 210 is equivalent to a second communicator. The second communication I/F 210 includes a communication card such as an NIC and performs data communication with the information processing device 100 each other via the network 3. In FIG. 2, an example in which the second communication I/F 210 is connected to the network 3 via a wired connection via a wired connection is illustrated. However, the connection between the projection device 200 and the network 3 may be wireless connection by Wi-Fi or the like. The second communication I/F 210 receives image data transmitted from the information processing device 100 and outputs the received image data to the image processor 220.

The image processor 220 performs image processing on image data loaded in a frame memory 230. The image processing performed by the image processor 220 includes, for example, resolution conversion processing or resize processing, correction of distortion aberration, shape correction processing, digital zoom processing, and adjustment of tint and brightness of an image. The image processor 220 reads image data from the frame memory 230 and outputs the read image data to the projector 240.

The projector 240 includes a light source, a light modulation device, a panel driver, and an optical unit. Illustration of the light source, the light modulation device, the panel driver, and the optical unit is omitted.

The light source includes a discharge-type light source lamp such as an ultra-high pressure mercury lamp or a metal halide lamp or a solid-state light source such as a light emitting diode or a semiconductor laser.

The light modulation device includes, for example, a transmissive liquid crystal panel. Image data output by the image processor 220 is input to the panel driver. The panel driver applies a drive voltage corresponding to input image data to pixels of a pixel region and sets the pixels to a light transmittance corresponding to the image data. Light output from the light source is transmitted through the pixel region of the liquid crystal panel to be modulated for each of the pixels and image light corresponding to the image data is formed. The optical unit includes a lens such as a projection lens and enlarges and projects the image light modulated by the light modulation device onto the projection surface 5.

The second controller 250 is a computer device including a second storage 260 and a second processor 270.

The second storage 260 includes a ROM and a RAM. The ROM stores data that is retained even when a power supply of the projection device 200 is turned off such as a control program. The RAM is used to temporarily store various data such as arithmetic data of the second processor 270.

The second processor 270 is an arithmetic processing device including a central processing unit (CPU) or a micro-processing unit (MPU). The second processor 270 may include a single processor or may include a plurality of processors.

### 4. Operation of the Information Processing Device

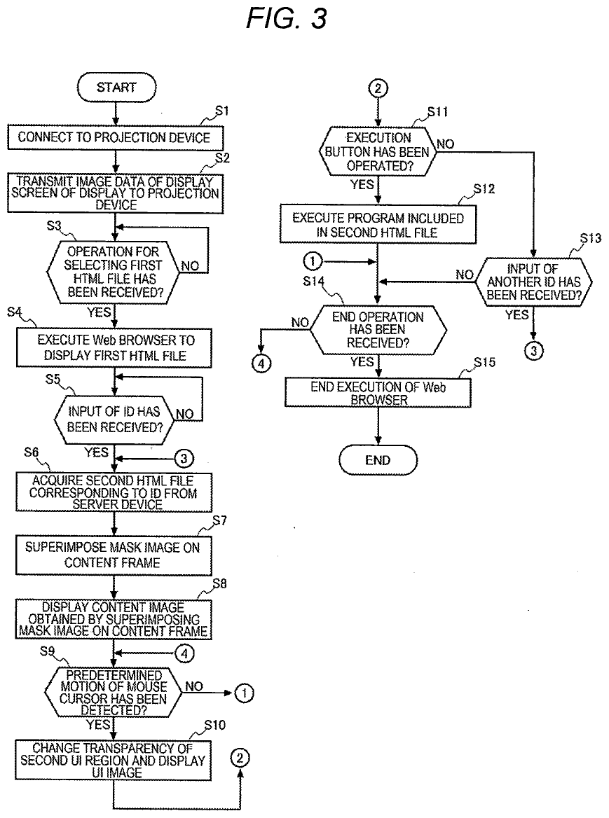

FIG. 3 is a flowchart illustrating an operation of the information processing device 100.

The operations of the information processing device 100 are described with reference to the flowchart illustrated in FIG. 3.

First, the information processing device 100 is connected to the projection device 200 (step S1) and image data of a display screen displayed on the display 130 is transmitted to the projection device 200 (step S2). The projection device 200 generates image light based on the image data received from the information processing device 100 and projects the generated image light onto the projection surface 5. Accordingly, a display screen displayed on the display 130 of the information processing device 100 is displayed on the projection surface 5.

Next, the first controller 150 determines whether operation of selecting the first HTML file 165 with operation of the mouse has been received (step S3). When the operation of selecting the first HTML file 165 has not been received (step S3/NO), the first controller 150 waits until the operation of selecting the first HTML file 165 is received.

Subsequently, when the operation of selecting the first HTML file 165 has been received (step S3/YES), the first controller 150 executes the web browser 163 to cause the display 130 to display the first HTML file 165 (step S4). A screen displayed on the display 130 when the first controller 150 executes the web browser 163 is referred to as the browser screen 300. Further, the first controller 150 transmits image data of the browser screen 300 displayed on the display 130 to the projection device 200, whereby the browser screen 300 is displayed on the projection surface 5 as well by the projection device 200.

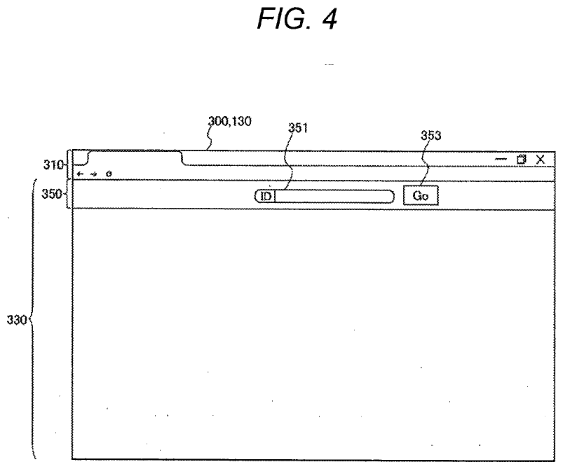

FIG. 4 illustrates an example of the browser screen 300 displayed by the web browser 163. The browser screen 300 illustrated in FIG. 4 is a screen displayed when the web browser 163 executes the first HTML file 165. The browser screen 300 includes a first UI region 310 and a display region 330. UI is an abbreviation for “User Interface”. The display region 330 is equivalent to a browser window.

In the first UI region 310, operation pieces of “return”, “advance”, and the like displayed by the web browser 163 are displayed.

The display region 330 is a region where a content image 400 and the like displayed by the web browser 163 executing the second HTML file acquired from the server device 10 are displayed. The display region 330 includes a second UI region 350.

In the second UI region 350, a UI image displayed by the web browser 163 executing the first HTML file 165 is displayed. That is, the UI image is displayed by a program included in the first HTML file 165. The UI image displayed in the second UI region 350 includes an ID search field 351 and a “GO” button 353 for instructing search execution.

When the browser screen 300 is displayed on the display 130, the first controller 150 determines whether input of an ID, which is identification information for identifying a second HTML file, has been received (step S5). Specifically, the first controller 150 determines whether an ID has been input to the ID search field 351 and the “GO” button 353 has been pressed. When input of an ID has not been received (step S5/NO), the first controller 150 waits until input of an ID is received.

When an ID is input to the ID search field 351 and the “GO” button 353 is pressed, the first controller 150 determines that the input of the ID has been received (step S5/YES). When the input of the ID has been received (step S5/YES), the first controller 150 accesses the server device 10 and acquires a second HTML file of the relevant ID from the server device 10 (step S6).

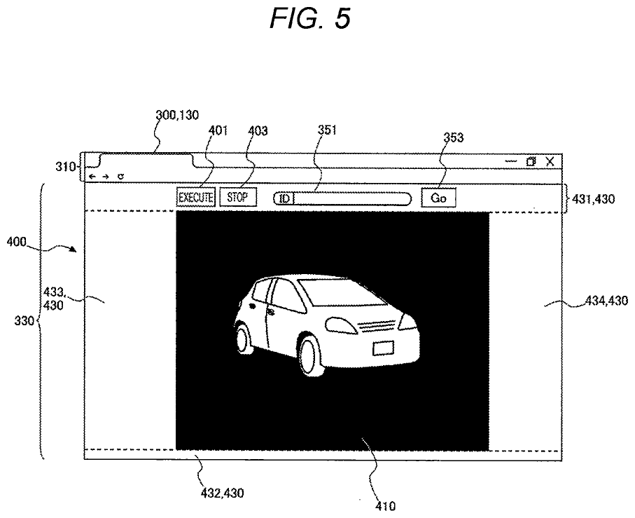

FIGS. 5, 6, and 7 are diagrams illustrating examples of the browser screen 300.

FIG. 5 is a diagram illustrating a state in which the second HTML file acquired from the server device 10 is executed and displayed as it is on the browser screen 300 without applying image processing of, for example, superimposing a mask image on the second HTML file. Although the browser screen 300 illustrated in FIG. 5 is illustrated for explanation, actually, the browser screen 300 illustrated in FIG. 5 is not displayed on the display 130.

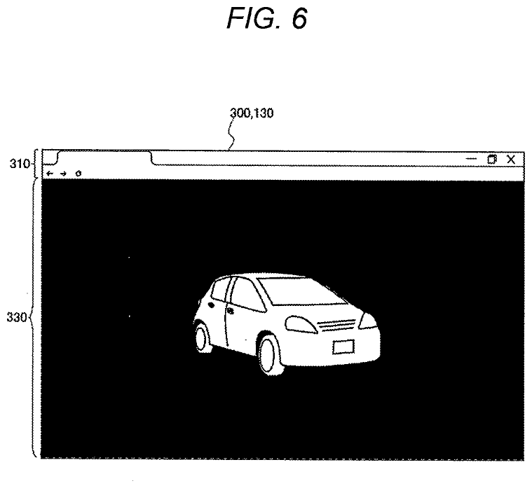

FIG. 6 is a diagram illustrating an image actually displayed on the browser screen 300. The browser screen 300 shown in FIG. 6 illustrates a state in which the first controller 150 applies image processing of, for example, superimposing a mask image on the second HTML file acquired from the server device 10 and displays the second HTML file on the browser screen 300.

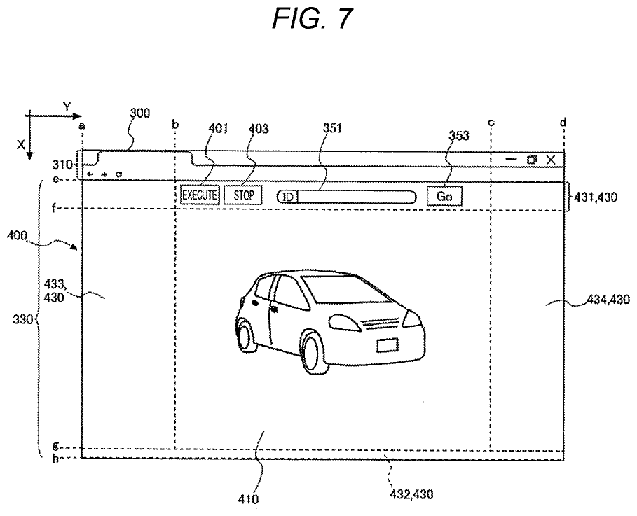

FIG. 7 is a diagram in which a display color of the display region 330 of the browser screen 300 illustrated in FIG. 6 is changed from black to white for explanation. An X direction illustrated in FIG. 7 corresponds to the up-down direction and a Y direction illustrated in FIG. 7 corresponds to the left-right direction in the drawing view.

First, the content image 400 displayed in the display region 330 is described with reference to FIG. 7.

The content image 400 is an image displayed in the display region 330 by the web browser 163 executing the second HTML file. The content image 400 includes a content display 410 and a content frame 430.

The content display 410 is equivalent to a first region. The content display 410 is a region where content that operates when the first controller 150 executes a program included in the second HTML file is displayed. FIG. 7 illustrates an image of a vehicle serving as the content.

A range of the content display 410 is a range between a broken line “f” and a broken line “g” illustrated in FIG. 7 in the X direction and is a range between a broken line “b” and a broken line “c” illustrated in FIG. 7 in the Y direction.

The content frame 430 is a range surrounding the periphery of the content display 410.

The content frame 430 includes a first content frame 431, a second content frame 432, a third content frame 433, and a fourth content frame 434. Note that the content frame 430 may be, for example, a range not including the second content frame 432 and surrounding a part of the periphery of the content display 410.

A range of the first content frame 431 is a range between a broken line “e” and the broken line “f” illustrated in FIG. 7 in the X direction and is a range between the broken line “a” and the broken line “d” illustrated in FIG. 7 in the Y direction. The first content frame 431 is equivalent to a first UI region.

In the first content frame 431, an execution button 401 and a stop button 403 are displayed besides the ID search field 351 and the “GO” button 353 displayed by the web browser 163 executing the first HTML file 165. An execution button 401 and a stop button 403 are UI images displayed by the web browser 163 executing the second HTML file. The ID search field 351 and the “GO” button 353 are equivalent to a first UI image.

The execution button 401 is a button for instructing the first controller 150 to execute the program included in the second HTML file. For example, when the execution button 401 is pressed, the first controller 150 executes the program included in the second HTML file and the image of the vehicle serving as the content moves or a blinker blinks as content.

The stop button 403 is a button for causing the first controller 150 to stop the execution of the program included in the second HTML file.

A range of the second content frame 432 is a range between the broken line “g” and a broken line “h” illustrated in FIG. 7 in the X direction and is a range between the broken line “a” and the broken line “d” illustrated in FIG. 7 in the Y direction.

A range of the third content frame 433 is a range between the broken line “g” and the broken line “h” illustrated in FIG. 7 in the X direction and is a range between the broken line “a” and the broken line “b” illustrated in FIG. 7 in the Y direction.

The range of the fourth content frame 434 is a range between the broken line “g” and the broken line “h” illustrated in FIG. 7 in the X direction and is a range between the broken line “c” and the broken line “d” illustrated in FIG. 7 in the Y direction.

The first controller 150 superimposes a mask image on the content frame 430 (step S7). Specifically, the first controller 150 superimposes the mask image on the first content frame 431, the second content frame 432, the third content frame 433, and the fourth content frame 434 illustrated in FIG. 7. The first content frame 431, the second content frame 432, the third content frame 433, and the fourth content frame 434 configuring the content frame 430 are equivalent to a second region.

A color of the mask image superimposed by the first controller 150 is the same as a color of a background of content displayed on the content display 410. The color of the mask image may be a color similar to the color of the background of the content or the color of the background of the content and the color of the mask image may have different shades. An image displayed on the content display 410 by the mask image being superimposed on the first content frame 431, the second content frame 432, the third content frame 433, and the fourth content frame 434 is equivalent to a composite image.

The browser screen 300 illustrated in FIG. 6 is displayed by superimposing the mask image on the first content frame 431, the second content frame 432, the third content frame 433, and the fourth content frame 434. That is, since the color of the background of the content and the color of the mask image are displayed in the same color as illustrated in FIG. 6, the content and the content frame 430 are recognized as one image for the user who visually recognizes an image displayed on the projection surface 5. An image with a sense of immersion can be displayed. As illustrated in FIG. 6, the first controller 150 displays, on the browser screen 300, the content image 400 obtained by superimposing the mouse image on the content frame 430 (step S8).

Here, the superimposition of the mask image on the first content frame 431, the second content frame 432, the third content frame 433, and the fourth content frame 434 is described.

For example, it is assumed that the second HTML file is a file described in “Scratch”, which is a visual programming language. Scratch is a registered trademark. In this case, sizes in the X direction of the first content frame 431 and the second content frame 432 displayed in the display region 330 by the web browser 163 executing the second HTML file are preset fixed sizes. An aspect ratio of the content display 410 is 4:3.

For example, it is assumed that a size of the first content frame 431 between the broken line “e” and the broken line “f” illustrated in FIG. 7 is [A] and a size of the second content frame 432 between the broken line “g” and the broken line “h” illustrated in FIG. 7 is [B].

The first controller 150 calculates a size of the third content frame 433 between the broken line “a” and the broken line “b” illustrated in FIG. 7 and a size of the fourth content frame 434 between the broken line “c” and the broken line “d” illustrated in FIG. 7 according to Expression (1) described below.

$$\{ 100 \% VW - [ 100 \% VH - ( A + B ) \times 4 \text{/3} ] \} / 2 \qquad ( 1 )$$

VW indicates the horizontal width of the display region 330 of the web browser 163.

VH indicates the vertical height of the display region 330 of the web browser 163.

VW and VH are values that are changed according to the resolution of the display 130.

In the first HTML file 165, portions surrounded by the first content frame 431, the second content frame 432, the third content frame 433, and the fourth content frame 434 are collectively treated as block elements using tags specified by HTML such as div tags.

A style tag included in the first HTML file 165 includes information specifying the positions of the first content frame 431, the second content frame 432, the third content frame 433, and the fourth content frame 434 and information indicating a vertical relationship thereof.

In the present embodiment, a case in which the first controller 150 calculates sizes in the Y direction of the third content frame 433 and the fourth content frame 434 and superimposes the mask image on the first content frame 431, the second content frame 432, the third content frame 433, and the fourth content frame 434 is described. However, the user may acquire sizes in the X direction and the Y direction of the first content frame 431, the second content frame 432, the third content frame 433, and the fourth content frame 434 from the second HTML file and manually set a region on which the mask image is superimposed in the first HTML file 165 based on information concerning the acquired sizes in the X direction and the Y direction.

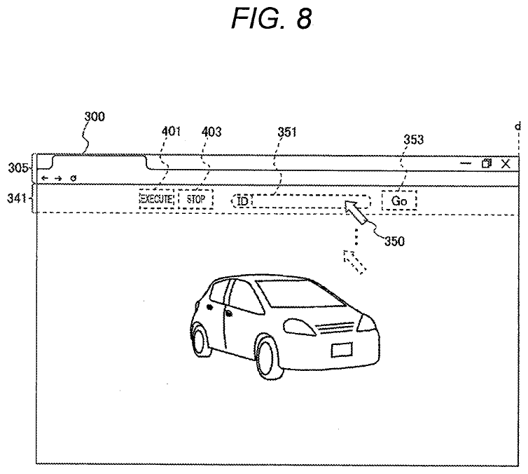

FIG. 8 is a diagram illustrating an image showing a predetermined motion of a mouse cursor.

Next, the first controller 150 determines whether a predetermined motion of a mouse cursor 350 has been detected (step S9).

The predetermined motion is described with reference to FIG. 8. As illustrated in FIG. 8, the predetermined motion is a motion of moving the mouse cursor 350 from the content display 410 to the first content frame 431. The predetermined motion may be a motion of moving the mouse cursor 350 from the third content frame 433 or the fourth content frame 434 to the first content frame 431.

When the motion of the mouse cursor 350 from the content display 410 to the first content frame 431 is not detected (step S9/NO), the first controller 150 proceeds to determination in step S14. The determination in step S14 is described below.

When the motion of the mouse cursor 350 from the content display 410 to the first content frame 431 has been detected (step S9/YES), as illustrated in FIG. 8, the first controller 150 changes the transparency of the mask image such that the user can visually recognize the first content frame 431 (step S10).

Subsequently, the first controller 150 determines whether operation of the execution button 401 displayed in the first content frame 431 has been received (step S11). When operation of the execution button 401 has not been received (step S11/NO), the first controller 150 proceeds to determination in step S13.

When operation of the execution button 401 has been received (step S11/YES), the first controller 150 executes the program included in the second HTML file (step S12). Accordingly, the image displayed on the content display 410 moves according to the program.

When operation of the execution button 401 has not been received (step S11/NO), the first controller 150 determines whether input of another ID has been received (step S13). When another ID is input to the ID search field 351 and the “GO” button 353 is pressed, the first controller 150 determines that input of another ID has been received. When input of another ID has been received (step S13/YES), the first controller 150 acquires a second HTML file corresponding to the ID received from the server device 10 (step S6) and executes the operations in step S7 and the subsequent steps again.

When the program included in the second HTML file has been executed (step S12) or when input of another ID has not been received (step S13/NO), the first controller 150 determines whether end operation has been received (step S14).

When the end operation has not been received (NO in step S14), the first controller 150 returns to the determination in step S9 and determines whether the predetermined motion of the mouse cursor 350 has been detected. When the end operation has been received (step S14/YES), the first controller 150 ends the execution of the web browser 163 (step S15) and ends the display of the browser screen 300.

### 5. Second Embodiment

A second embodiment is described with reference to the accompanying drawings.

Configurations of the information processing device 100 and the projection device 200 in the second embodiment are the same as the configurations in the first embodiment illustrated in FIG. 2. For this reason, the configurations of the information processing device 100 and the projection device 200 according to the second embodiment are not described.

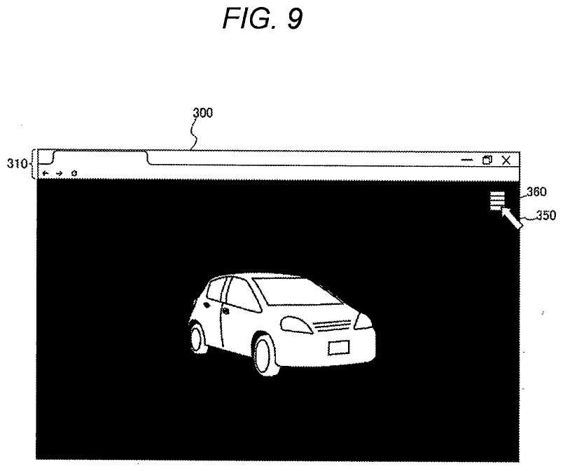

FIG. 9 is a diagram illustrating an example of the browser screen 300 in the second embodiment.

In the second embodiment, the first content frame 431 is arranged in a layer below the first UI region 310 of the web browser 163. That is, since the first content frame 431 is located in the layer below the first UI region 310, the first content frame 431 is hidden by the first UI region 310 and is not displayed on the browser screen 300.

On the second content frame 432, the third content frame 433, and the fourth content frame 434 of the content image 400, a mask image having the same color as a color of a background of content displayed on the content display 410 is superimposed as in the first embodiment. Therefore, for a user who visually recognizes an image displayed on the projection surface 5, the content and the content frame 430 are recognized as one image and visually recognized as an image with a sense of immersion.

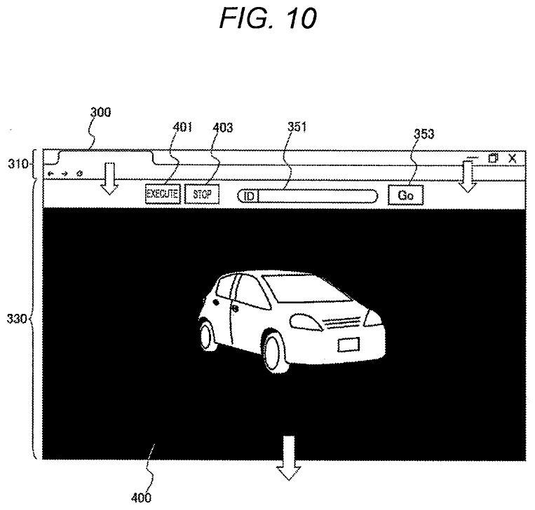

FIG. 10 is a diagram illustrating the content image 400 displayed on the browser screen 300 when an operation piece 360 is operated.

As illustrated in FIG. 9, the operation piece 360 is displayed in the display region 330. The operation piece 360 is equivalent to a third UI image. The operation piece 360 is an operation piece displayed by the first controller 150 executing the first HTML file 165.

When the operation piece 360 is selected by mouse operation, the first controller 150 moves a display position of the content image 400 downward in the drawing view as illustrated in FIG. 10. Accordingly, the first content frame 431 located in a layer below the first UI region 310 is displayed in the display region 330. For this reason, the user is capable of operating the execution button 401, the stop button 403, the ID search field 351, and the “GO” button 353 displayed in the first content frame 431.

For example, when operation of the execution button 401, the stop button 403, or the “GO” button 353 displayed in the first content frame 431 has been received or when the operation has not been successfully received even if operation of the user has been waited for a fixed time, a display position of the content image 400 is returned to the original position illustrated in FIG. 9. That is, the content image 400 is moved upward such that the first content frame 431 is arranged below the first UI region 310.

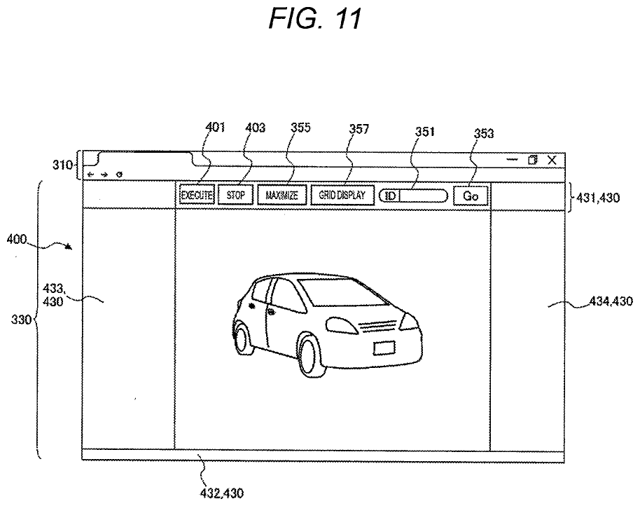

FIG. 11 is a diagram illustrating an example in which a UI image displayed in the second UI region 350 is changed.

In FIG. 7, the second UI region 350 including the ID search field 351, the “GO” button 353, the execution button 401, and the stop button 403 is illustrated.

In FIG. 11, an example in which a maximization button 355 and a grid display button 357 are added as UI images displayed in the second UI region 350 is illustrated. The maximization button 355 and the grid display button 357 are UI images displayed by the web browser 163 executing the first HTML file 165.

The maximization button 355 is a button for receiving an instruction to cause the entire screen of the display 130 to display the display region 330. When the maximization button 355 is pressed, the first controller 150 causes the display 130 to display, on the entire screen, an image displayed in the display region 330.

The grid display button 357 is a button for receiving an instruction to cause the display region 330 to display a grid that is perpendicularly intersecting vertical and horizontal straight lines. When the grid display button 357 is pressed, the first controller 150 causes the display region 330 to display the grid superimposed on the content and the mask image displayed on the content display 410.

The embodiment described above is a preferred mode of implementation of the present disclosure. The present disclosure is, however, not limited to the embodiment described above, and various modified implementations are possible without departing from the gist of the present disclosure.

For example, in the embodiment described above, a case in which the transmissive liquid crystal panel is provided as the light modulation device is exemplified. However, the liquid crystal panel may be a reflective liquid crystal panel. The light modulation device may have a configuration in which a digital mirror device is used instead of the liquid crystal panel. The light modulation device may have a configuration in which the digital mirror device and a color wheel are combined. As the light modulation device, a configuration capable of modulating light emitted by the light source may be adopted besides the liquid crystal panel and the digital mirror device.

The functional units of the projection device 200 illustrated in FIG. 1 indicate functional components and specific implementation forms of the functional units are not particularly limited. That is, hardware individually corresponding to the functional units does not always need to be implemented. It is also naturally possible to adopt a configuration in which one processor executes a program to implement functions of a plurality of functional units. A part of functions implemented by software in the embodiment may be implemented by hardware or a part of functions implemented by hardware in the embodiment may be implemented by software. Besides, specific detailed configurations of the other units of the projector can also be optionally changed without departing from the gist of the present disclosure.

The processing units of the flowchart illustrated in FIG. 7 are divided according to main processing contents in order to facilitate understanding of processing of the projection device 200. The present disclosure is not limited by the way division and names of the processing units illustrated in the flowchart of FIG. 7. According to processing contents, the processing of the projection device 200 can also be divided into a larger number of processing units or one processing unit can also be divided to include a larger number of kinds of processing. The processing order of the flowchart described above is not limited to the illustrated example either.

### 6. Summary of the Present Disclosure

A summary of the present disclosure is appended below.

### APPENDIX 1

A display system including: a display device configured to display an image on a display surface; and an information processing device, wherein the information processing device includes: a first communicator; a display; and a first controller configured to perform: acquiring, by executing a first HTML file with a web browser, a second HTML file; superimposing, on a second region excluding a first region where content included in the acquired second HTML file is displayed, a mask image having a same color as the background color of the first region to generate composite image data; causing a browser window displayed on the display by the web browser to display a composite image based on the composite image data; and transmitting the composite image data to the display device, and the display device includes: a second communicator; and a display configured to display, on the display surface, a composite image based on the composite image data received by the second communicator.

The display system described in Appendix 1 superimposes, on the second region excluding the first region where the content included in the second HTML file is displayed, the mask image having the same color as the background color of the first region to generate the composite image data. The generated composite image data is displayed on the browser window displayed on the display, transmitted to the display device, and displayed on the display surface in the display device.

For this reason, even when the device resolution of the display and the resolution of the second region do not coincide, it is possible to cause a user to visually recognize the first region and the second region as one image without causing the user to recognize separation of the first region and second region and it is possible to display a content image with a sense of immersion.

### APPENDIX 2

The display system described in Appendix 1, wherein the information processing device includes an operation unit, and the first controller executes the first HTML file to superimpose a first UI region including a first UI image for receiving operation of the operation unit on the second region of the composite image to be masked by the mask image, and, when operation of selecting the first UI region is received by the operation unit, changes transparency of the mask image superimposed on the first UI region such that the first UI image can be visually recognized.

In the display system described in Appendix 2, the first UI region including the first UI image is superimposed on the second region of the composite image to be masked by the mask image. When the operation of selecting the first UI region is received, the transparency of the mask image superimposed on the first UI region is changed such that the first UI image can be visually recognized. Therefore, when the first UI image is desired to be used, the first UI region can be displayed and, when the first UI image is not used, the first UI image can be masked by the mask image not to be visually recognized.

### APPENDIX 3

The display system described in Appendix 1, wherein the information processing device includes an operation unit, and the first controller displays the composite image on the browser window such that a first UI region including a first UI image generated by executing the first HTML file is arranged in a layer below a second UI region including a second UI image displayed by the web browser, executes the first HTML file to display a third UI image on the composite image, and, when operation of the third UI image is received by the operation unit, changes a display position of the composite image in the browser window such that the first UI region is displayed on the browser window.

In the display system described in Appendix 3, the composite image is displayed on the browser window such that the first UI region including the first UI image is arranged below the second UI region including the second UI image displayed by the web browser. The third UI image is displayed on the composite image. When the operation of the third UI image is received, the display position of the composite image in the browser window is changed such that the first UI region is displayed on the browser window. Therefore, when the first UI image is desired to be used, the first UI region can be displayed and, when the first UI image is not used, the first UI image can be arranged in the layer below the second UI region such that the first UI image is not visually recognized.

### APPENDIX 4

The display system described in Appendix 2, wherein the first controller executes the first HTML file to display a plurality of UI images including the first UI image in the first UI region superimposed on the second region of the composite image.

The display system described in Appendix 4 can display the plurality of UI images including the first UI image in the first UI region by executing the first HTML file.

### APPENDIX 5

The display system described in Appendix 4, wherein the plurality of UI images include at least one of a UI image for receiving identification information for identifying the second HTML file and a UI image for receiving operation of causing the display to maximize and display the browser window.

In the display system described in Appendix 5, the plurality of UI images include the UI image for receiving the identification information for identifying the second HTML file and the UI image for receiving the operation of causing the display to maximize and display the browser window. For this reason, by inputting the identification information to the UI image, it is possible to display the second HTML file corresponding to the identification information or cause the display to maximize and display the browser window.

### APPENDIX 6

The display system described in Appendix 1, wherein the information processing device includes an operation unit configured to receive an operation, and the first controller superimposes the mask image on the second region designated by the operation received by the operation unit.

The display system described in Appendix 6 can superimpose the mask image on the second region designated by the operation received by the operation unit. Therefore, even when sizes of the first region and the second region displayed by executing the second HTML file are different, the mask image can be superimposed on the second region by operation of the user.

### APPENDIX 7

An information processing device including: a first communicator; a display; and a first controller configured to perform: acquiring, by executing a first HTML file with a web browser to execute, a second HTML file; superimposing, on a second region excluding a first region where content included in the acquired second HTML file is displayed, a mask image having a same color as the background color of the first region to generate composite image data; causing a browser window displayed on the display by the web browser to display a composite image based on the composite image data; and transmitting the composite image data to the display device.

The information processing device described in Appendix 7 superimposes, on the second region excluding the first region where the content included in the second HTML file is displayed, the mask image having the same color as the background color of the first region to generate the composite image data. The generated composite image data is displayed on the browser window displayed on the display, transmitted to the display device, and displayed on the display surface in the display device. For this reason, even when the device resolution of the display and the resolution of the second region do not coincide, it is possible to cause a user to visually recognize the first region and the second region as one image without causing the user to recognize separation of the first region and second region and it is possible to display a content image with a sense of immersion.

### APPENDIX 8

A control method for an information processing device including a first communicator configured to communicate with a display device; and a display, the control method causing a computer mounted on the information processing device to execute a first HTML file with a web browser to perform: acquiring a second HTML file; superimposing, on a second region excluding a first region where content included in the acquired second HTML file is displayed, a mask image having a same color as the background color of the first region to generate composite image data; causing a browser window displayed on the display by the web browser to display a composite image based on the composite image data; and transmitting the composite image data to the display device.

The control method for the information processing device described in Appendix 8 includes superimposing, on the second region excluding the first region where the content included in the second HTML file is displayed, the mask image having the same color as the background color of the first region to generate the composite image data. The generated composite image data is displayed on the browser window displayed on the display, transmitted to the display device, and displayed on the display surface in the display device. For this reason, even when the device resolution of the display and the resolution of the second region do not coincide, it is possible to cause a user to visually recognize the first region and the second region as one image without causing the user to recognize separation of the first region and second region and it is possible to display a content image with a sense of immersion.

What is claimed is:

1. A display system comprising:
a display device configured to display an image on a display surface; and
an information processing device, wherein
the information processing device includes:
a first communicator;
a display; and
a first controller configured to perform:
acquiring, by executing a first HTML file with a web browser to execute, a second HTML file;
superimposing, on a second region excluding a first region where content included in the acquired second HTML file is displayed, a mask image having a same color as the background color of the first region to generate composite image data;
causing a browser window displayed on the display by the web browser to display a composite image based on the composite image data; and
transmitting the composite image data to the display device, and
the display device includes:
a second communicator; and
a display configured to display, on the display surface, a composite image based on the composite image data received by the second communicator.

2. The display system according to claim 1, wherein
the information processing device includes an operation unit, and
the first controller executes the first HTML file to superimpose a first UI region including a first UI image for receiving operation of the operation unit on the second region of the composite image to be masked by the mask image, and, when operation of selecting the first UI region is received by the operation unit, changes transparency of the mask image superimposed on the first UI region such that the first UI image can be visually recognized.

3. The display system according to claim 1, wherein
the information processing device includes an operation unit, and
the first controller displays the composite image on the browser window such that a first UI region including a first UI image generated by executing the first HTML file is arranged in a layer below a second UI region including a second UI image displayed by the web browser, executes the first HTML file to display a third UI image on the composite image, and, when operation of the third UI image is received by the operation unit, changes a display position of the composite image in the browser window such that the first UI region is displayed on the browser window.

4. The display system according to claim 2, wherein the first controller executes the first HTML file to display a plurality of UI images including the first UI image in the first UI region superimposed on the second region of the composite image.

5. The display system according to claim 4, wherein the plurality of UI images include at least one of a UI image for receiving identification information for identifying the second HTML file and a UI image for receiving operation of causing the display to maximize and display the browser window.

6. The display system according to claim 1, wherein
the information processing device includes an operation unit configured to receive an operation, and
the first controller superimposes the mask image on the second region designated by the operation received by the operation unit.

7. An information processing device comprising:
a first communicator;
a display; and
a first controller configured to perform:
acquiring, by executing a first HTML file with a web browser to execute, a second HTML file;
superimposing, on a second region excluding a first region where content included in the acquired second HTML file is displayed, a mask image having a same color as the background color of the first region to generate composite image data;
causing a browser window displayed on the display by the web browser to display a composite image based on the composite image data; and
transmitting the composite image data to the display device.

8. A control method for an information processing device including a first communicator configured to communicate with a display device; and a display, the control method causing a computer mounted on the information processing device to execute a first HTML file with a web browser to perform:
acquiring a second HTML file; superimposing, on a second region excluding a first region where content included in the acquired second HTML file is displayed, a mask image having a same color as the background color of the first region to generate composite image data;
causing a browser window displayed on the display by the web browser to display a composite image based on the composite image data; and
transmitting the composite image data to the display device.
